(19) United States
(12) Patent Application Publication
(10) Pub. No.: US 2026/0079227 A1
(43) Pub. Date: Mar. 19, 2026

(54) OBJECT LOCATION THROUGH MEDIA-PLAYBACK DEVICES

(71) Applicant: DISH Network Technologies India Private Limited, Bengaluru (IN)

(72) Inventor: Srinidhi An, Shivamogga (IN)

(73) Assignee: DISH Network Technologies India Private Limited, Bengaluru (IN)

(21) Appl. No.: 18/888,876

(22) Filed: Sep. 18, 2024

(51) Int. Cl. G01S 5/02; G06T 11/60

(52) U.S. Cl. CPC G01S 5/02526; G01S 5/0263; G06T 11/60

(57) ABSTRACT

One example of an automated process for locating objects can include configuring a media-playback device with a map. A first position of the media-playback device can be located on the map to reflect a first location of the media-playback device in a structure corresponding to the map. The media-playback device may detect a second location of a device in the structure. The media-playback device may render a second position of the device on the map to reflect the second location of the device in the structure. Other examples and related methods, devices, systems, and articles are also disclosed herein.

### TECHNICAL FIELD

The following generally relates to locating objects. More particularly, the following relates to systems, devices, and automated processes that locate objects using a media-playback device.

### BACKGROUND

In modern society, individuals often experience frustration and inconvenience when attempting to locate misplaced belongings within their homes or workplaces. The problem of lost objects can impact vulnerable populations that are prone to diminished memory capacity, such as seniors living in assisted living facilities. The problem of lost items is exacerbated by the hectic pace of daily life and the diverse array of objects that people use and store. Frequently misplaced items may include keys, wallets, mobile devices, remote controls, and various other personal or household items.

Traditional methods of searching for lost items typically involve visual inspection of likely locations, such as tabletops, drawers, or shelves, which can be time-consuming and often ineffective. Despite efforts to maintain organization, the dynamics of daily activities often lead to items being misplaced in unexpected places, resulting in lost time and heightened stress for the individuals searching for them.

Moreover, existing solutions for locating lost objects, such as audible tracking devices or manual checklists, often lack the necessary precision and ease of use to consistently and reliably pinpoint the location of a lost item within a house or structure. Thus, there remains a significant need in the art for an improved system and method that can accurately and efficiently locate lost objects within a confined space, thereby alleviating the frustrations and inefficiencies associated with traditional search methods.

### BRIEF SUMMARY

Systems, methods, devices, and computer-readable media of the present disclosure can be used to locate devices and objects wirelessly. An example of an automated process can include the steps of configuring a media-playback device with a map; locating a first position of the media-playback device on the map to reflect a first location of the media-playback device in a structure corresponding to the map; and detecting, by the media-playback device, a second location of a device in the structure. The media-playback device may render a second position of the device on the map to reflect the second location of the device in the structure.

An example computing device may include a processor in electronic communication with a non-transitory computer-readable medium storing instructions thereon that, when executed by the processor, cause the computing device to perform operations. The operations may include configuring a computing device with a map, locating a first position of the computing device on the map to reflect a first location of the computing device in a structure corresponding to the map, and detecting, by the computing device, a second location of a device in the structure. The computing device may render a second position of the device on the map to reflect the second location of the device in the structure.

An example of a non-transitory computer-readable medium can store instructions thereon that, upon execution, cause a processor to perform operations. The operations can include configuring a computing device with a map, locating a first position of the computing device on the map to reflect a first location of the computing device in a structure corresponding to the map, and detecting, by the computing device, a second location of a device in the structure. The computing device may render a second position of the device on the map to reflect the second location of the device in the structure. Other embodiments of this aspect include corresponding computer systems, apparatus, and computer programs recorded on one or more computer storage devices, each configured to perform the actions of the methods.

Various embodiments may include updating, by the media-playback device, fingerprinting data of the map to increase an accuracy of the second position of the device on the map reflecting the second location of the device in the structure. The device transmits a Bluetooth or ultra-wideband (UWB) signal received by the media-playback device and useable to detect the second location of the device in the structure. The device transmits a WiFi signal received by the media-playback device and useable to detect the second location of the device in the structure. The device may include a tag coupled to an object. The second position of the device on the map is rendered with a name of the object. The second position of the device on the map is rendered with an image of the object. A user selects the second position of the device on the map to update fingerprinting data of the map. The media-playback device uses a time of flight and an angle of arrival of an ultra-wideband signal to detect the second location of the device in the structure. The media-playback device uses a direction finding (DF) capability of a Bluetooth protocol to detect the second location of the device in the structure. Implementations of the described techniques may include hardware, a method or process, or computer software on a computer-accessible medium.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example computing device, in accordance with various embodiments.

FIG. 2 illustrates an example system for locating objects using Bluetooth or ultra-wide-band signals, in accordance with various embodiments.

FIG. 3 illustrates an example system locating objects using WIFI signals, in accordance with various embodiments.

FIG. 4 illustrates an example process for locating devices using wireless signals received at a set-top box or other computing device, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices (collectively, the “System”) of the present disclosure may locate smartphones or other objects using wireless transmissions. The System can be integrated into wireless gateways, wireless access points, Bluetooth enabled devices, or ultra-wide-band (UWB) devices to precisely locate signal sources. Objects such as smart phones running native wireless transmission standards can be paired to a media-playback device over Bluetooth or other wireless transmission channels. Objects such as remote controls, keys, or wallets can be tagged with a transmitter identifiable on the media-playback device.

In various embodiments, the media-playback device may be configured with a map or floor plan of the facility or area in which it is located. The media-playback device is located and oriented on the map by a user. Once configured and oriented with a map, the media-playback device can identify the location of tagged or paired objects on the map with a high degree of precision.

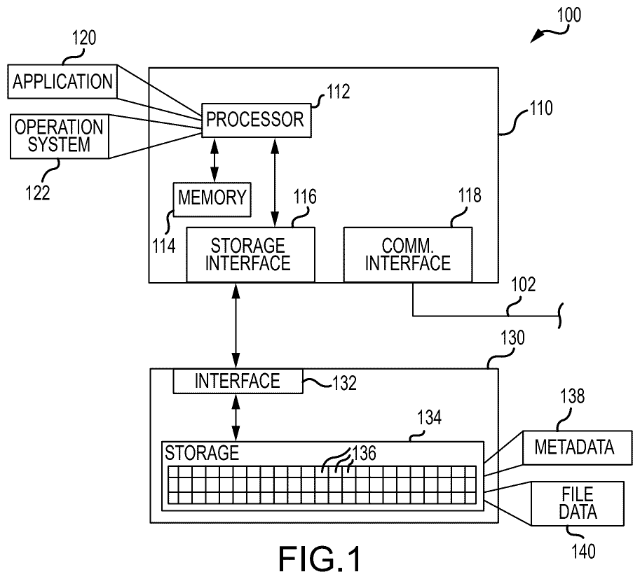

Referring now to FIG. 1, an example computing device 100 is shown, in accordance with various embodiments. Computing device 100 can comprise a laptop, computer, server, smartphone, media-playback device, set-top box (STB), placeshifting device, playback device, or other type of computing device compatible with the systems, methods, and devices described herein.

In various embodiments, computing device 100 may include a processing component 110 and a storage component 130. Computing device 100 may include one or more user interfaces, for input or output such as a keyboard, mouse, track ball, touch pad, touch screen, and/or a display. Processing component 110 may include a processor 112 and a memory 114. Memory 114 may be in electronic communication with processor 112. Processor 112 may include one or more microprocessors, co-processors, logic devices, and/or the like. Processor 112 comprising multiple microprocessors may execute in parallel or asynchronously. The logic device may include, for example, analog-to-digital converters, digital-to-analog converters, buffers, multiplexers, clock circuits, or any other peripheral devices required for operation of processor 112.

Memory 114 may include a single memory device or multiple memory devices and may be volatile memory, non-volatile memory, or a combination thereof. In some embodiments, memory 114 may comprise a non-transitory memory configured to store instructions thereon that, when executed by processor 112 or computing device 100, cause the respective processor or computing device to perform operations. The operations can comprise operations or process steps described herein.

In some embodiments, processing component 110 may also comprise a storage interface 116 in electronic communication with processor 112. Storage interface 116 may be configured to provide a physical connection to storage component 130. For example, in response to storage component 130 may comprise an internal hard drive or solid-state storage device. Storage interface 116 may include, for example, appropriate cables, drivers, and the like to enable the physical connection. As a further example, in response to storage component 130 comprising a removable storage medium, such as a CD-ROM drive, DVD-ROM drive, USB drive, memory card, and the like, storage interface 116 may comprise an interface, a port, a drive, or the like configured to receive the removable storage medium and any additional hardware required to operate the interface, the port, the drive, or the like.

Processing component 110 may also comprise a communication interface 118 in electronic communication with processor 112. Communication interface 118 may be, for example, a serial communication port, a parallel communication port, an Ethernet communication port, or the like. Device 100 may comprise a communication medium 102. Communication medium 102 may be configured to enable electronic communication between processing component 110 and network 104. Communication medium 102 may be a cable, such as an Ethernet cable. In various embodiments, communication interface 118 may be configured for wireless communication via infrared, radio frequency (RF), WIFI®, optical, BLUETOOTH®, or other suitable wireless communication methods. Communication medium 102 may comprise one or more antennas configured to enable communication over free-space. Network 104 may be an intranet, the Internet, or a combination thereof. Each computing device 100 in a system may communicate with another device either directly or indirectly via a network.

In some examples, computing device 100 may interact wirelessly with other computing devices 100 or with signal-emitting tags. For example, Bluetooth tags or UWB tags can emit a wireless signal detected by computing device 100. Bluetooth and UWB can comprise low-energy signals enabling tags emitting such signals to operate for long periods of time and consume a small amount of energy. Some embodiments can use WIFI transmissions between two or more points to triangulate a location, though WIFI transmission tends to consume more energy than Bluetooth or UWB transmissions.

In various embodiments, computing device 100 can use the signal to locate the tag emitting the signal relative to the location of computing device 100. For example, a STB can receive a signal from a UWB tag coupled to a television remote control by an adhesive material. The STB can use the signal to locate the UWB tag and thus the remote control.

In various embodiments, storage component 130 may comprise any suitable database, data structure, or the like capable of storing and/or maintaining data. Storage component 130 may comprise, for example, a hard drive, a solid-state drive, a removable memory card, and the like. Storage component 130 may comprise an interface 132 configured to enable communications with processing component 110, via storage interface 116. For example, storage interface 116 in processing component 110 and interface 132 in the storage component 130 define the physical layers between the processing component 110 and storage component 130, respectively, establishing communication therebetween. In various embodiments, storage component 130 includes block storage 134, with multiple blocks 136, in which data and files are saved. Each file stored in the storage component 130 may include metadata 138 and file data 140. Metadata 138 for a file includes, for example, pointers to particular blocks 136 in block storage 134 at which the file data 140 for the file is stored.

In some embodiments, metadata 138 can include names assigned to devices paired or registered with computing device 100. In that regard, computing device 100 can locate a device using signal location techniques, and display the location of the device in conjunction with a device name or other identifying metadata.

In various embodiments, computing device 100 may be deployed within a system as part of, or to form, a distributed network. The distributed network may be based on one or more computing devices in wireless communication on a network.

In various embodiments, processor 112 in each device 100 may be configured to execute applications 120, as well as an operating system 122 for the device 100. Operating system 122 manages the resources of the device 100 and provides common services between applications 120 executing on processor 112. Operating system 122 may be stored on storage component 130, within memory 114, or a combination thereof. Operating system 122 may vary between devices 100 and is configured to control the hardware components for the associated device 100. Processor 112 may be configured to execute operating system 122 and each of the applications 120 stored in memory 114 or storage component 130.

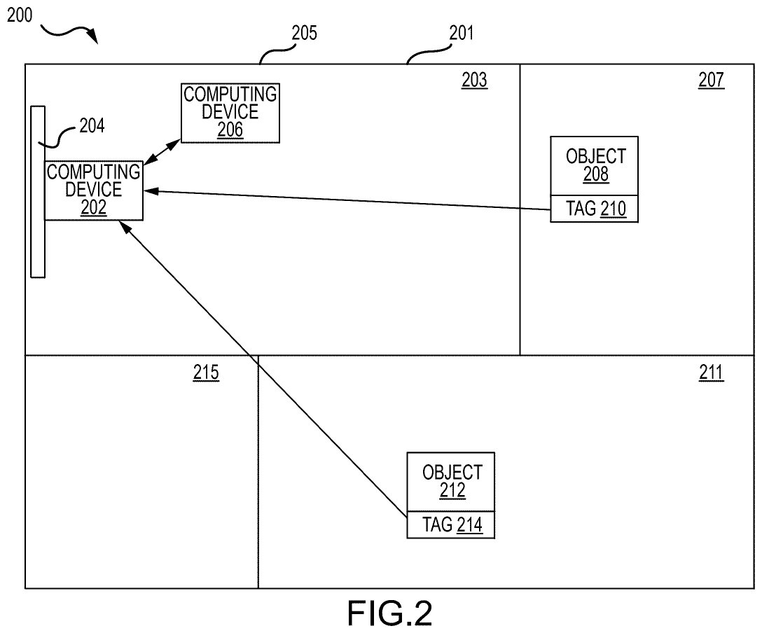

With reference to FIG. 2, An example system 200 is shown for locating objects using Bluetooth or UWB signals, in accordance with various embodiments. System 200 comprises structure 201 depicted as a floor plan 205 suitable for rendering on computing device 202. A floor plan can also be referred to herein as a map, layout, ground plan, or blueprint. Computing device 202 can be in electronic communication with display device 204. Display device 204 can render floor plan 205 stored on computing device 202 to map the location of devices in structure 201.

In the example of FIG. 2, floor plan 205 of structure 201 comprises room 203, room 207, room 211, and room 215. In other examples, any number, shape, or configuration of rooms, spaces, areas, patios, or regions can be included in map or floor plan 205. Continuing the example of FIG. 2, computing device 206 (e.g., a smartphone) may be paired with computing device 202 (e.g., an STB). Computing device 206 is located in room 203 of structure 201. Computing device 202 can use a wireless signal from computing device 206 to locate computing device 206 in room 203.

In the example of FIG. 2, the location can be determined using Bluetooth, UWB, or other wireless signals. Computing device 202 can then render a representation of computing device 206 the corresponding location of computing device 206 in floor plan 205 for viewing on display 204.

In various embodiments, object 208 (e.g., keys) may be coupled to tag 210. Tag 210 emits a signal detectable by computing device 202. For example, tag 210 may emit a Bluetooth or UWB signal receivable by computing device 202. Object 208 and coupled tag 210 are located in room 207 of structure 201. Computing device 202 (e.g., an STB) can use a wireless signal from tag 210 to locate object 208 in room 207. In the example of FIG. 2, the location can be determined using Bluetooth, UWB, or other wireless signals emitted from tag 210. Computing device 202 can then render a representation of object 208 at the corresponding location of tag 210 in floor plan 205 for viewing on display 204.

In various embodiments, object 212 (e.g., a wallet or purse) may be coupled to or may contain tag 214. Tag 214 emits a signal detectable by computing device 202. For example, tag 214 may emit a Bluetooth or UWB signal receivable by computing device 202. Object 212 and coupled tag 214 are located in room 211 of structure 201. Computing device 202 (e.g., an STB) can use a wireless signal from tag 214 to locate object 212 in room 207. In the example of FIG. 2, the location can be determined using Bluetooth, UWB, or other wireless signals emitted from tag 214. Computing device 202 can then render a representation of object 212 at the corresponding location of tag 214 in floor plan 205 for viewing on display 204.

In a UWB-based example, system 200 may employ techniques that leverage the unique characteristics of UWB signals (e.g., wide bandwidths typically greater than 500 MHz). One of the primary methods used for location detection is Time-of-Flight (ToF) ranging, where the distance between a transmitter and receiver is calculated based on the time it takes for a UWB pulse to travel between them. This is achieved with high accuracy due to the narrow pulse widths (less than a nanosecond) of UWB signals, allowing precise measurement of propagation time. ToF ranging can be enhanced by employing multiple antennas or antenna arrays in computing device 202 or in elsewhere in or around structure 201 to improve spatial resolution and accuracy in locating objects or devices.

In various embodiments, system 200 may employ Angle of Arrival (AoA) estimation, which determines the direction from which a UWB signal arrives at an antenna array. By comparing the phase differences of the signal received at different antennas, AoA can be calculated with high precision. This method is particularly useful in applications requiring directional awareness, such as tracking movements in indoor environments or localizing assets within large spaces. AoA estimation can also be combined with ToF ranging to achieve even greater accuracy in 3D positioning of computing device 206, object 208, or object 212 within floor plan 205.

Various embodiments may support the use of Received Signal Strength Indicator (RSSI) for proximity detection and coarse localization. Although not as precise as ToF or AoA methods, RSSI provides a simple way to estimate distance based on signal attenuation. Overall, UWB location detection techniques offer versatile solutions for a range of applications from precise indoor positioning to robust asset tracking in complex environments, leveraging the unique capabilities of UWB signals for accurate spatial awareness.

In a Bluetooth-based example, location detection techniques can leverage Bluetooth Low Energy (BLE) for location detection. BLE can implement RSSI based trilateration, which estimates the distance between a mobile device and several fixed Bluetooth beacons by measuring the strength of the received signal. By using the RSSI values from multiple beacons and knowing their locations, the position of the mobile device can be determined relative to these beacons.

In various embodiments, BLE-based implementations can use AoA and Angle of Departure (AoD) estimation using Bluetooth Direction Finding (DF) capabilities. With the introduction of Bluetooth 5.1 and later versions, devices equipped with Direction Finding antennas can estimate the direction from which a Bluetooth signal is transmitted or received. By measuring the phase differences or time delays of signals received at multiple antennas, AoA or AoD can be calculated to determine the angle relative to the antenna array. This technique enables more precise localization of devices in both indoor and outdoor environments, offering higher accuracy compared to RSSI-based methods.

Bluetooth location detection techniques can also integrate with fingerprinting methods, where signal strength measurements (e.g., RSSI) from multiple Bluetooth beacons are combined with a database of signal patterns across a location. This approach creates a fingerprint of structure 201 that can be used to match current RSSI measurements to known locations in floor plan 205, providing accurate positioning information. Fingerprinting may be useful in scenarios where precise positioning is critical, such as indoor navigation in malls, airports, or large buildings.

In various embodiments, computing device 202 can include or be coupled to multiple antennas or arrays, or to other computing devices or beacons including antennas or arrays, to implement the foregoing techniques. Computing device 202 locates devices and objects by rendering the calculated position of the devices and objects over floor plan 205 on display 204. Users can improve the signal fingerprinting of computing device 202 by correcting the location where a device or object was found in structure 201 in response to the found location deviating from the location rendered over floor plan 205.

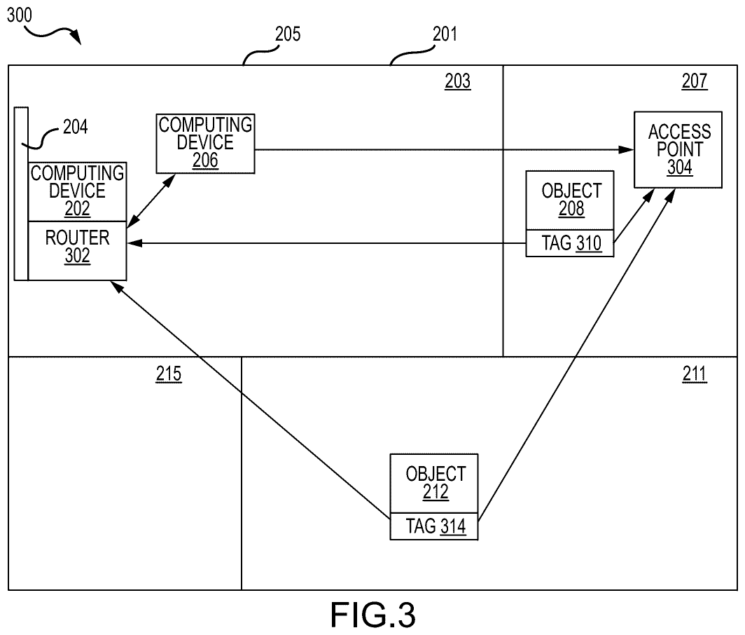

Referring now to FIG. 3, an example system 300 is shown for locating objects using Wifi signals, in accordance with various embodiments. In the example of FIG. 3, elements using the same reference numbers as in FIG. 2 are similar to or the same as the elements of FIG. 2. System 300 comprises structure 201 depicted as a floor plan 205 suitable for rendering on computing device 202. Computing device 202 can be in electronic communication with display device 204. Display device 204 can render floor plan 205 stored on computing device 202 to map the location of devices in structure 201. Computing device 202 can also be in electronic communication with router 302 and wireless access point (AP) 304. Although devices and tags are depicted as communicating solely with router 302 and AP 304 in the example of FIG. 3, computing device 202 may also be Wifi enabled and may communicate with devices and tags to identify the locations of the devices and tags. Wireless AP 304, router, and computing device 202 can be various types of APs into the same WiFi network routed by router 302.

In various embodiments, computing device 206 (e.g., a smartphone) can be in communication with router 302 and AP 304. Tags 310 and 314 can also be in communication with router 302 and AP 304 by emitting WiFi signals. Router 302 and AP 304 can be used to triangulate locations of computing device 206, object 208, or object 212.

In WiFi-based embodiments, system 300 may use the unique identifiers of WiFi tags, devices, and APs to pinpoint a location. Each WiFi device or tag can transmit a WiFi signal with identifying information. Computing device 202 with WiFi capability can scan for WiFi signals and can detect nearby devices along with their signal strengths and identifying information. The signals can be detected at router 302, AP 304, or computing device 202 at multiple known locations and the signal characteristics (e.g., signal strength) at each location may be compared. By comparing this information with a database or map of known WiFi AP locations, computing device 202 can estimate the location of computing device 206, object 208 (by tag 310), and object 212 (by tag 314) based on the strength and proximity of the detected signals.

This technique can be referred to as WiFi positioning or WiFi fingerprinting. WiFi positioning may provide relatively accurate location data indoors and in urban environments where GPS signals may be weak or unavailable.

In various embodiments, computing device 202 can include or be coupled to multiple antennas or arrays, or to other computing devices or beacons including antennas or arrays, to implement the WiFi positioning techniques. Computing device 202 locates devices and objects by rendering the calculated position of the devices and objects over floor plan 205 on display 204. Users can improve the signal fingerprinting of computing device 202 by correcting the location where a device or object was found in structure 201 in response to the found location deviating from the location rendered over floor plan 205.

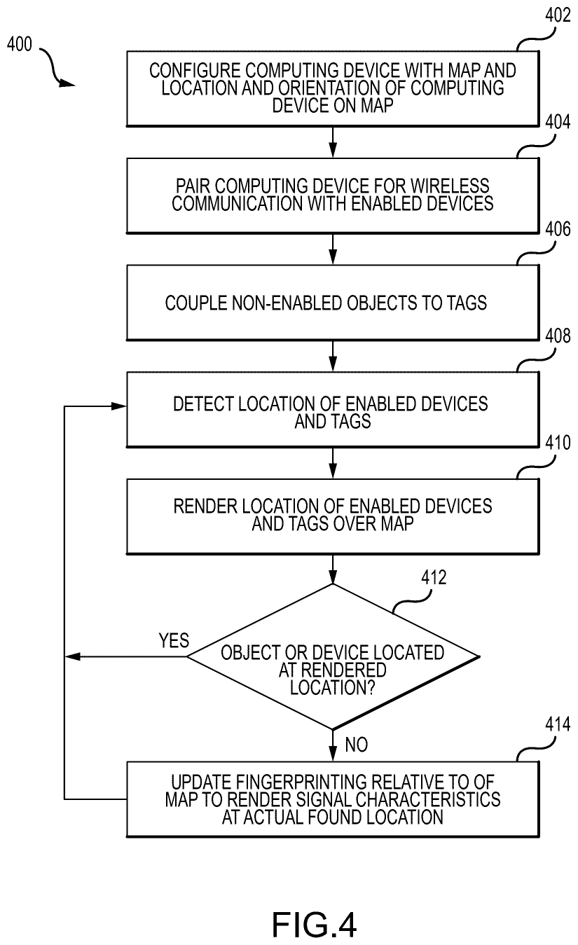

Referring now to FIG. 4, an example process 400 for locating devices or objects is shown, in accordance with various embodiments. Computing device 202 may be configured with map 205 and location and orientation of computing device 202 on map 205 (Block 402). In a STB-based example, the STB (computing device 202 in this example) may render map 205 on display 204. Using a remote-control or smartphone paired to the STB, a user can move an icon or pointer associated with the STB on map 205 until the position of the STB in structure 201 is accurately represented on map 205.

Continuing the foregoing example, once the location of the STB is set on map 205, the user can rotate the map or otherwise orient the map relative to the STB. The map can be manually rotated by user until the user's remote, smartphone, or a tag in a known location within structure 201 is rendered correctly in the corresponding location of map 205. In another example of orientation techniques, the STB can instruct the user to take a transmitting device (e.g., a remote, smartphone, tag, or other device transmitting a signal detected by the STB) to a designated location in structure 201. The user may indicate to the STB once the transmitting device is in the designated location, and the STB can reorient map 205 to render the transmitting device in the corresponding location. These fingerprinting steps can be repeated until the STB is oriented and reproduces locations on map 205 that accurately reflect positions in structure 201.

In various embodiments, computing device 202 may be paired for wireless communication with enabled devices (Block 404). For example, a smartphone may be paired with computing device 202. Paired devices can be automatically populated in a device table stored in computing device 202. Paired devices can automatically be rendered on map 205 using the device type, host name, or other device-specific data available over the pairing connection.

In various embodiments, non-enabled devices may be coupled to tags (Block 406). The tags may be wireless transmitting tags capable of broadcasting a Bluetooth, UWB, WiFi, or other trackable signal. For example, a UWB tag may comprise an adhesive or tape stickable to the surface of an object. In other examples, a UWB tag can be placed in a compartment of a purse or wallet, coupled to a key ring, placed in a pocket of a coat, or glued to an object. Transmitting tags may be coupled to objects using any suitable adhesive or coupling technique.

Computing device 202 may detect the location of enabled devices and tags (Block 408), in accordance with various embodiments. Computing device may use the WiFi, Bluetooth, or UWB techniques described herein, or any other suitable wireless location techniques. Once located, computing device 202 can render the location of enabled devices and tags over map 205 (Block 410) using display 204.

In various embodiments, computing device 202 may enable fingerprinting revisions while rendering locations of devices and tags on map 205. Users can select the device or tag rendered on map 205 in response to the rendered location inaccurately reflecting the actual location in structure 201. The user can move the icon representing the tag or device to a location on map 205 accurately reflecting the actual location of the device or tag in structure 201. The user may also update identifying information such as, for example, device name, nick name, host name, or other metadata for association with the device or tag. For example, a tag coupled to a purse may be updated to include the description “small blue handbag” on the map. The icon representing the device or tag can also be updated with stock images or with actual photographs of the device or object coupled to the tag. Continuing with the small blue handbag, a photograph of the handbag may be uploaded to computing device 202 by a paired smartphone or other device.

In various embodiments, computing device may during fingerprinting prompt a user to decide whether a tagged object or device was actually located at the rendered location on map 205 (Block 412). The user may repeat steps described above or apply other fingerprinting techniques to improve the location renders on map 205 made by computing device 202.

In various embodiments, computing device 202 may update fingerprinting data relative to of map to render similar signal characteristics at actual found location (Block 414). Fingerprinting data can be used to more accurately map similar tags or devices to accurate locations on map 205. Fingerprinting data can include signal strength, angles, RSSI, ToF, AoA, AoD, DF, or other signal characteristics applicable to the location technology implemented by computing device 202. The fingerprinting data can be associated with a location on map 205 using coordinates or other location rendering techniques to identify a location on map 205 corresponding to the stored fingerprinting data. In some examples, the fingerprinting data can be device or tag specific and applied only to the device for which the user identified an actual location on map 205. In some examples, the fingerprinting data can be applied to groups of devices or tags to improve location renders on map 205.

The System disclosed herein tends to improve device tracking for individuals. Devices can be accurately located on a map or floor plan of an area. The System thus tends to reduce the time spent locating lost or misplaced devices or objects.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more. ” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment (for example, A and B, A and C, B and C, or A and B and C).

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S. C. 112(f) unless the element is expressly recited using the phrase “means for. ” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process comprising:
configuring a media-playback device with a map;
locating a first position of the media-playback device on the map to reflect a first location of the media-playback device in a structure corresponding to the map;
detecting, by the media-playback device, a second location of a device in the structure; and
rendering, by the media-playback device, a second position of the device on the map to reflect the second location of the device in the structure.

2. The automated process of claim 1, further comprising updating, by the media-playback device, fingerprinting data of the map to increase an accuracy of the second position of the device on the map reflecting the second location of the device in the structure.

3. The automated process of claim 1, wherein the device transmits a Bluetooth or ultra-wideband (UWB) signal received by the media-playback device and useable to detect the second location of the device in the structure.

4. The automated process of claim 1, wherein the device transmits a WiFi signal received by the media-playback device and useable to detect the second location of the device in the structure.

5. The automated process of claim 1, wherein the device comprises a tag coupled to an object.

6. The automated process of claim 5, wherein the second position of the device on the map is rendered with a name of the object.

7. The automated process of claim 5, wherein the second position of the device on the map is rendered with an image of the object.

8. The automated process of claim 1, wherein a user selects the second position of the device on the map to update fingerprinting data of the map.

9. The automated process of claim 1, wherein the media-playback device uses a time of flight and an angle of arrival of an ultra-wideband signal to detect the second location of the device in the structure.

10. The automated process of claim 1, wherein the media-playback device uses a direction finding (DF) capability of a Bluetooth protocol to detect the second location of the device in the structure.

11. A computing device comprising a processor in electronic communication with a non-transitory computer-readable medium storing a set of instructions thereon that, when executed by the processor, cause the computing device to perform operations, the operations comprising:
configuring the computing device with a map;
locating a first position of the computing device on the map to reflect a first location of the computing device in a structure corresponding to the map;
detecting, by the computing device, a second location of a device in the structure; and
rendering, by the computing device, a second position of the device on the map to reflect the second location of the device in the structure.

12. The computing device of claim 11, wherein the operations further comprise updating, by the computing device, fingerprinting data of the map to increase an accuracy of the second position of the device on the map reflecting the second location of the device in the structure.

13. The computing device of claim 11, wherein the device transmits a Bluetooth or ultra-wideband (UWB) signal received by the computing device and useable to detect the second location of the device in the structure.

14. The computing device of claim 11, wherein the device comprises a tag coupled to an object.

15. The computing device of claim 14, wherein the second position of the device on the map is rendered with a name of the object.

16. The computing device of claim 14, wherein the second position of the device on the map is rendered with an image of the object.

17. The computing device of claim 11, wherein the computing device uses a time of flight and an angle of arrival of an ultra-wideband signal to detect the second location of the device in the structure.

18. The computing device of claim 11, wherein the computing device uses a direction finding (DF) capability of a Bluetooth protocol to detect the second location of the device in the structure.

19. A non-transitory computer-readable medium storing instructions thereon that, when executed by a processor, causes a media-playback device to perform operations, the operations comprising:
configuring the media-playback device with a map;
locating a first position of the media-playback device on the map to reflect a first location of the media-playback device in a structure corresponding to the map;
detecting, by the media-playback device, a second location of a device in the structure; and
rendering, by the media-playback device, a second position of the device on the map to reflect the second location of the device in the structure.

20. The non-transitory computer-readable medium of claim 19, wherein the operations further comprise updating, by the media-playback device, fingerprinting data of the map to increase an accuracy of the second position of the device on the map reflecting the second location of the device in the structure.
